(19) United States
(12) Patent Application Publication
(10) Pub. No.: US 2006/0006855 A1
(43) Pub. Date: Jan. 12, 2006

(54) Charge pump DC/DC converter with constant-frequency operation

(76) Inventors: Wei-Wen Feng, Taipei (TW); Jian-He Li, Hsinchu (TW)

Correspondence Address: RAYMOND Y. CHAN, 108 N. YNEZ AVE., SUITE 128, MONTEREY PARK, CA, 91754, US

(21) Appl. No.: 10/888,161

(22) Filed: Jul. 8, 2004

(51) Int. Cl. G05F 1/40

(52) U.S. Cl. 323/282

(57) ABSTRACT

A DC/DC voltage converter includes a charge pump circuit including a pump capacitor coupling at an output node, a switching device for switching the charge pump circuit between a first phase and a second phase, and an adjustable resistor for adjusting a magnitude of the output voltage at the second phase, wherein at the first phase, a current flows to charge the pump capacitor, and at the second phase, said current flows from the pump capacitor to the output node. A feedback loop circuitry is electrically coupling with the charge pump circuit for generating a control signal to the adjustable resistor to control the output voltage at the output node in a constant manner when said current is increased. Therefore, the voltage converter is adapted to perform good load regulation ability to prevent variations and fluctuations in the output voltage corresponding to load variations and fluctuations.

### BACKGROUND OF THE PRESENT INVENTION

1. Field of Invention

The present invention relates to a charge pump DC/DC converter, and more particularly to a charge pump DC/DC converter with constant-frequency operation which is adapted to perform good load regulation ability so as to prevent variations or fluctuations in the output voltage corresponding to load variations or fluctuations.

2. Description of Related Arts

A charge pump DC/DC converter is known as a power supply circuit that provides a regulated output voltage to a load from an input voltage source. One type of charge pump DC/DC converter is a switching DC/DC converter power supply that uses switches to convert the input voltage to a regulated output voltage. The switches are operated in sequence to first charge a capacitor from the input voltage and then transfer the charge to the output.

However, one of the most common drawbacks of the conventional charge pump DC/DC converter with constant-frequency operation is variations or fluctuations in the output voltage due to load variations or fluctuations. In operation, the conventional charge pump DC/DC converter with constant-frequency operation may not perform good load regulation ability so as to prevent the variations in the output voltage corresponding to load variations or fluctuations. In other words, the output voltage will linearly decrease when the output current or load current increases. The voltage change appears on the output voltage. The magnitude of the change in the output voltage depends upon the magnitude of the change in the output current or load current. Therefore, the variations or fluctuations in the output voltage caused by load variations or fluctuations must be eliminated to prevent degraded electrical performance in other circuitry that is power from the output voltage of the charge pump DC/DC converter.

FIG. 1 is a graph of typical output current versus output voltage for conventional charge pump DC/DC converter with constant-frequency operation. A previously known charge pump DC/DC converter is the LTC 1522 which is discussed in LTC's (Linear Technology Corporation) 1997 databook. Linear Technology Corporation markets a micropower charge pump DC/DC converter, the LTC 1522, that produces a regulated 5V±4% output voltage. The graph of output current versus output voltage characteristic of LTC 1522 is shown in page 3 of LTC 1522 Micropower, Regulated 5V Charge Pump DC/DC Converter, Linear Technology Corporation, 1997. Although this charge pump DC/DC converter is referred to in its product specification sheet as a “regulated charge pump DC/DC converter”, it nevertheless has the shortcoming that it produces large variations or fluctuations on the regulated output voltage due to the load variations or fluctuations.

Thus, it would therefore be desired to provide an improved charge pump DC/DC converter with constant-frequency operation that provides a substantially constant regulated output voltage.

It would therefore also be desired to provide an improved charge pump DC/DC converter with constant-frequency operation that provides a substantially constant regulated output voltage corresponding to the load variations or fluctuations.

### SUMMARY OF THE PRESENT INVENTION

A main object of the present invention is to provide a DC to DC voltage converter with constant-frequency operation which is adapted to perform good load regulation ability so as to prevent variations or fluctuations in the output voltage corresponding to load variations or fluctuations.

Another object of the present invention is to provide a DC to DC voltage converter with constant-frequency operation that provides a substantially constant regulated output voltage.

Another object of the present invention is to provide a DC to DC voltage converter with constant-frequency operation that provides a substantially constant regulated output voltage corresponding to the load variations or fluctuations.

Another object of the present invention is to provide a DC to DC voltage converter with constant-frequency operation that provides a substantially constant regulated output voltage corresponding to the variations or fluctuations in output current or load current.

These and other objects of the present invention are provided by DC to DC voltage converters including circuitry to reduce variations in the regulated output voltage corresponding to the load variations or fluctuations, and methods for using the same. Accordingly, in order to accomplish the above objects, the present invention provides a DC to DC voltage converter, comprising:

a first capacitor;

a first transistor coupled between the first capacitor and the output node;

a second transistor coupled to the first capacitor, wherein a current alternatively flows from an input voltage to the first capacitor and from the first capacitor to the output node;

a feedback loop circuitry that monitors a voltage at the output node and generates a control signal; and

a third transistor coupled between the input voltage and the second transistor, wherein the voltage at the output node is controlled by an impedance of the third transistor, which is responsive to the control signal when the third transistor and the first transistor are turned on.

These and other objectives, features, and advantages of the present invention will become apparent from the following detailed description, the accompanying drawings, and the appended claims.

### BRIEF DESCRIPTION OF THE DRAWINGS

FIG. 1 is a graph of output current versus output voltage of a DC to DC voltage converter according to a first preferred embodiment of the present invention, illustrating the voltage converter of the present invention providing a constant voltage output while the current is varied in comparison with a conventional voltage converter.

FIG. 2 is a schematic diagram of the DC to DC voltage converter according to the above first preferred embodiment of the present invention.

FIGS. 3A to 3B are schematic diagrams of current flow of the DC to DC voltage converter according to the above first preferred embodiment of the present invention.

FIG. 3C illustrates an equivalent circuit of a charge pump circuit in operation according to the above first preferred embodiment of the present invention.

FIG. 4 is a schematic diagram of the DC to DC voltage converter according to a second preferred embodiment of the present invention.

FIGS. 5A to 5B are schematic diagrams of current flow of the DC to DC voltage converter according to the above second preferred embodiment of the present invention.

### DETAILED DESCRIPTION OF THE PREFERRED EMBODIMENT

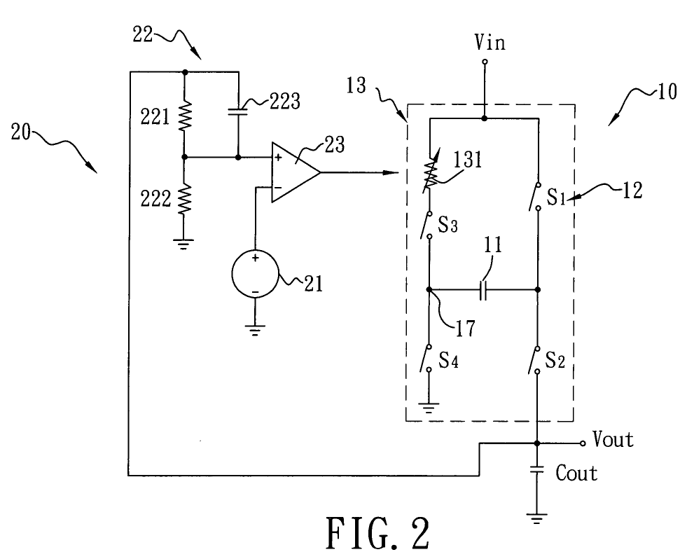

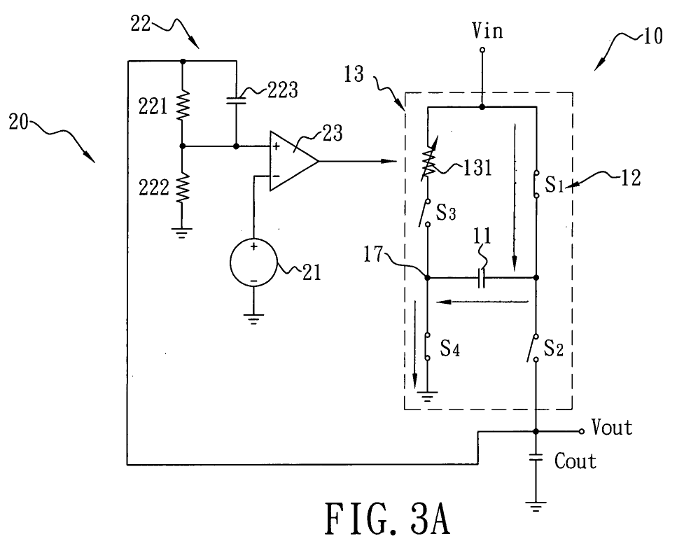

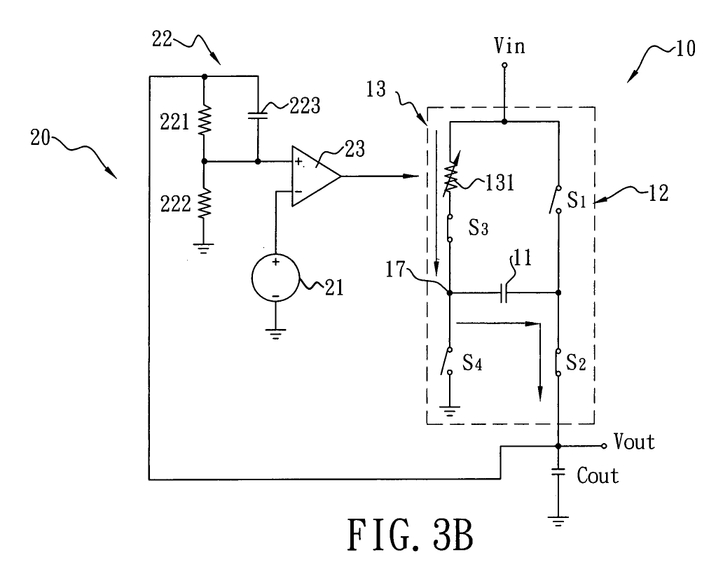

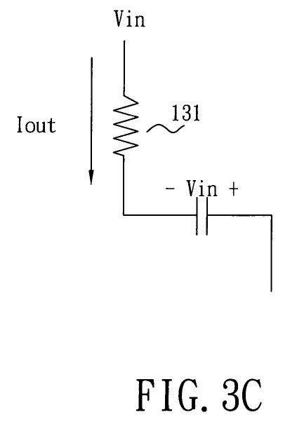

Referring to FIGS. 2, 3A, and 3B of the drawings, a DC to DC voltage converter according to a first embodiment of the present invention is illustrated, wherein the voltage converter is arranged for regulating an output voltage Vₒᵤₜ at an output node Nₒᵤₜ from an input voltage Vᵢₙ. Accordingly, the voltage converter comprises a charge pump circuit 10, a feedback loop circuitry 20 and an output capacitor Cₒᵤₜ.

The charge pump circuit 10 comprises a pump capacitor 11 coupling at the output node Nₒᵤₜ, means 12 for switching the charge pump circuit 10 between a first phase and a second phase, and means 13 for adjusting a magnitude of the output voltage Vₒᵤₜ at the second phase, wherein at the first phase, a current flows to the pump capacitor 11 so as to charge the pump capacitor 11, and at the second phase, the current flows from the pump capacitor 11 to the output node Nₒᵤₜ.

The feedback loop circuitry 20 is electrically coupling with the charge pump circuit 10 for generating a control signal to the adjusting means 13 so as to control the output voltage Vₒᵤₜ at said output node Nₒᵤₜ in a constant manner when the current is varied.

According to the preferred embodiment, the charge pump circuit 10 supplies the regulated output voltage Vₒᵤₜ at an output node Nₒᵤₜ from the input voltage Vᵢₙ. The switching means 12 comprises a plurality of switches S1, S2, S3, and S4. The first and fourth switches S1, S4 are switched out of phase with the second and third switches S2, S3 by clock signals Φ1 and Φ2, respectively.

During the first phase, the first and fourth switches S1, S4 are closed while the second and third switches S2, S3 are opened, as shown in FIG. 3A, the pump capacitor 11 therefore is charged to the input voltage Vᵢₙ during the first phase. During the second phase, the first and fourth switches S1, S4 are opened while the second and third switches S2, S3 are closed, the current flows from the pump capacitor 11 to the output node Nₒᵤₜ, as shown in FIG. 3B.

According to the first embodiment, the adjusting means 13 comprises an adjustable resistor 131, having a variable resistance, coupled in series between the input voltage Vᵢₙ and the pump capacitor 11, wherein the adjustable resistor 131 is responsive to the control signal to adjust the variable resistance at the second phase so as to control the output voltage Vₒᵤₜ.

The feedback loop circuitry 20 comprises a reference voltage source 21 providing a reference voltage signal, a resistor divider 22 coupling with the adjusting means 22 for generating a voltage feedback signal thereto and an amplifier 23 amplifying the voltage feedback signal with respect to the reference voltage signal so as to generate the control signal to the adjusting means 13.

The resistor divider 22 is coupled to the output voltage Vₒᵤₜ varies the resistance of adjustable resistor 131 through the amplifier 23 so that the output voltage Vₒᵤₜ is maintained at a desired regulated voltage. In other words, the feedback loop circuitry 20 is used to control the resistance of adjustable resistor 131 and thereby control the output voltage Vₒᵤₜ at a desired regulated voltage. The resistor divider 22 comprises two resistors 221, 222, and a capacitor 223. The resistor divider 22 provides a voltage feedback signal proportional to output voltage Vₒᵤₜ at the inverting input of the amplifier 23. The reference voltage source 21 provides a constant reference voltage signal at the non-inverting input of the amplifier 23. The amplifier 23 amplifies the difference between the feedback signal and the reference voltage and provides an amplified signal at its output to control the resistance of adjustable resistor 131. Accordingly, a field effect transistor (such as a P-channel MOSFET) that is operated in its linear region may be utilized instead of the adjustable resistor 131 and the third switch S3. The first to fourth switches S1-S4 (and all other switches discussed with respect to the present invention) may comprise FETs (such as MOSFETs) or BJTs (bipolar junction transistors).

Referring to FIGS. 2 and 3C of the drawings, the voltage at node 17 when the first and fourth switches S1, S4 are opened, and the second and third switches S2, S3 are closed during the second phase is shown in the following equation:
Vᵢₙ−Iₒᵤₜ*R=V₁₇ (1)
where V₁₇ is the voltage at node 17, R is the resistance of adjustable resistor 131, and Iₒᵤₜ is an output current. The output voltage Vₒᵤₜ at the output node Nₒᵤₜ is shown in the following equation:
Vₒᵤₜ=V₁₁+V₁₇ (2)
where V₁₁ is the voltage across the pump capacitor 11.

Substituting equation (1) into equation (2), one can derive the following equation:
Vₒᵤₜ=Vᵢₙ+(Vᵢₙ−Iₒᵤₜ*R)=2Vᵢₙ−Iₒᵤₜ*R (3)

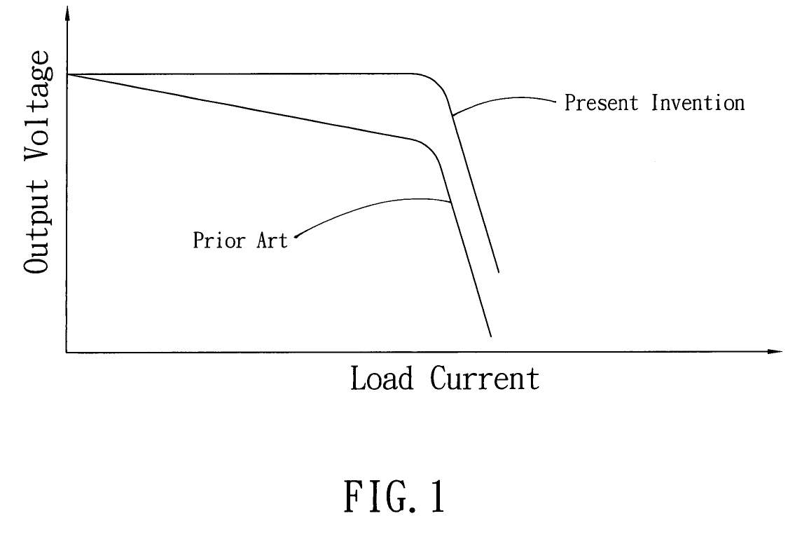

For the above discussion, the first to fourth switches S1 to S4 are operated in sequence to first charge the pump capacitor 11 from the input voltage Vᵢₙ and then transfer the charge to the output. Therefore, the magnitude of the output voltage Vₒᵤₜ is adjusted by the resistance of adjustable resistor 131. Therefore, when the load of the voltage converter of the present invention is either from heavy to light or from light to heavy, the output voltage will remain in a constant manner, as shown in FIG. 1. It is worth to mention that when the load of the conventional voltage converter is from heavy to light, the output voltage will increase and when the load of the conventional voltage converter is from light to heavy, the output voltage will decrease.

Instead of adjustable resistor 131 and the third switch S3, the voltage converter of the present invention may include a field effect transistor (such as a P-channel MOSFET) coupled to the input voltage that conducting a voltage drop cross the field effect transistor to maintain the output voltage at a desired regulated voltage when the field effect transistor is turn on and operated in its linear region during each phase of the switching cycle.

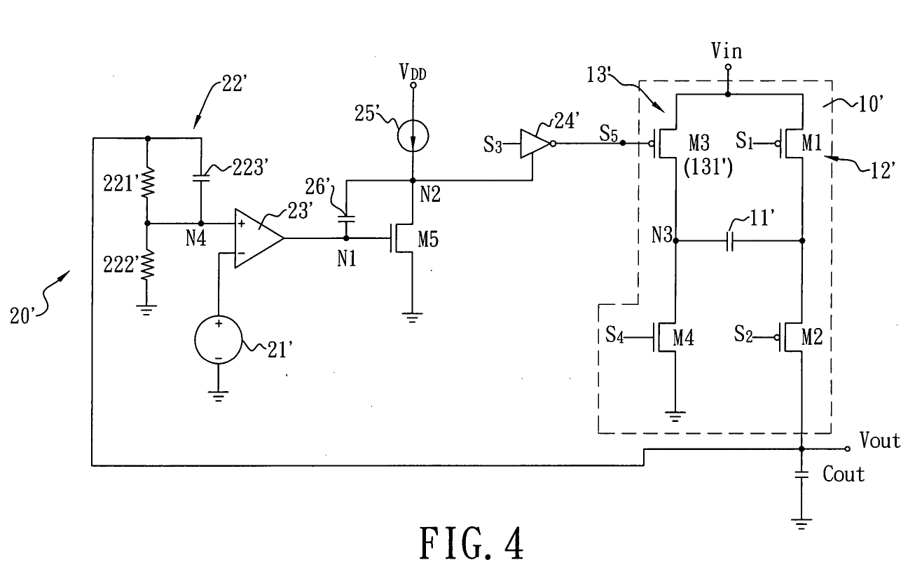

As shown in FIG. 4, a DC to DC voltage converter of a second embodiment illustrates an alternative mode of the first embodiment of the present invention by using transistors instead of switches is shown in FIG. 4, wherein the voltage converter comprises a charge pump circuit 10′, a feedback loop circuitry 20′ and an output capacitor Cₒᵤₜ.

According to the second embodiment, the charge pump circuit 10′ comprises a pump capacitor 11′ coupling at the output node Nₒᵤₜ, means 12′ for switching the charge pump circuit 10′ between a first phase and a second phase, and means 13′ for adjusting a magnitude of the output voltage Vₒᵤₜ at the second phase, wherein at the first phase, a current flows to the pump capacitor 11′ so as to charge the pump capacitor 11′, and at the second phase, the current flows from the pump capacitor 11′ to the output node Nₒᵤₜ.

The feedback loop circuitry 20′ is electrically coupling with the charge pump circuit 10′ for generating a control signal to the adjusting means 13′ so as to control the output voltage Vₒᵤₜ at said output node Nₒᵤₜ in a constant manner when the current is increased.

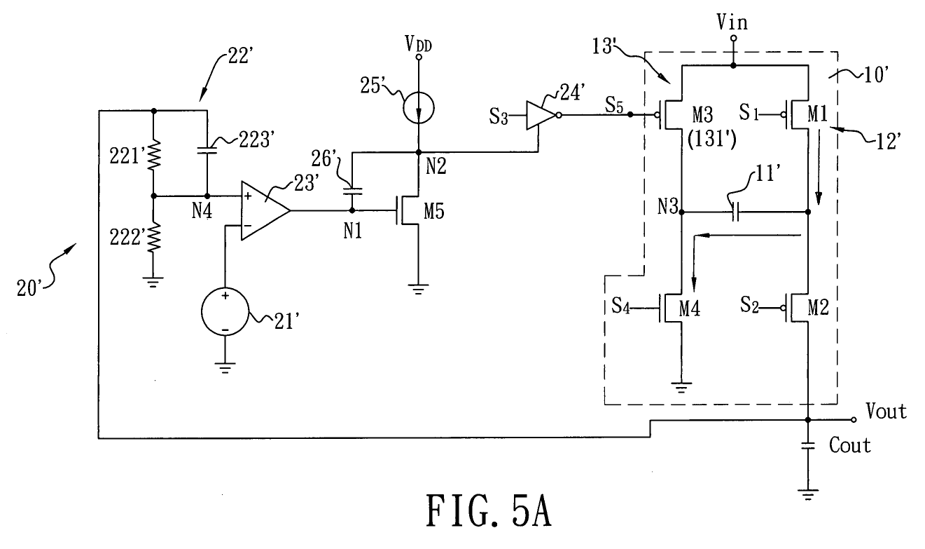

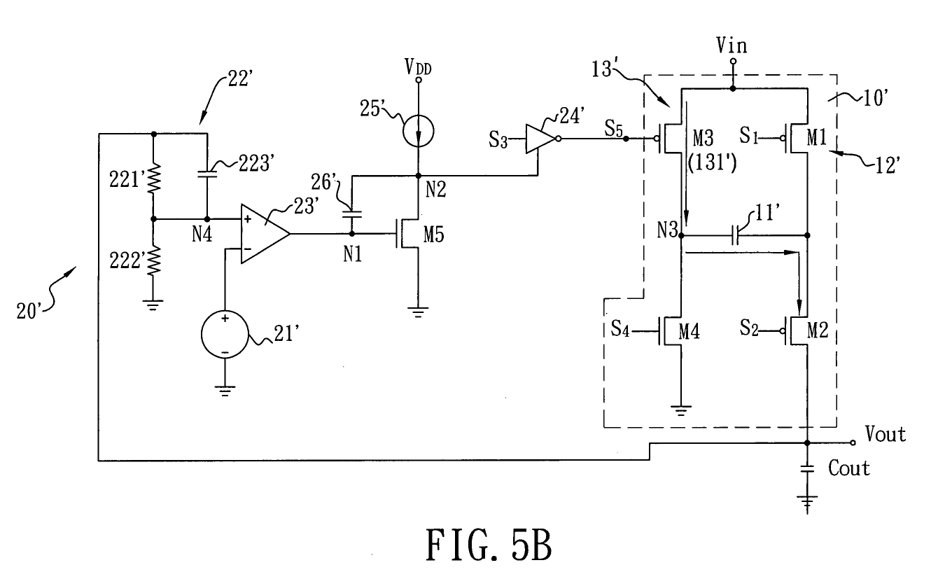

The charge pump circuit 10′ supplies a regulated output voltage Vₒᵤₜ at the output node Nₒᵤₜ from the input voltage Vᵢₙ. The switching means 12′ comprises a plurality of transistors M1 to M4, wherein the first, second and third transistors M1, M2, M3 are p-channel transistors respectively and the fourth transistor M4 is a n-channel transistor. The first and fourth transistors M1, M4 are switched out of phase with the second and third transistors M2, M3 by clock signals Φ1 and Φ2, respectively. The control electrode of the first transistor M1 is connected to receive a clock signal Φ1. The control electrode of the fourth transistor M4 is connected to receive a clock signal Φ2 which is out of phase with Φ1. The control electrode of second transistor M2 is connected to receive the clock signal Φ2. The control electrode of transistor M3 is connected to receive the clock signal Φ1. During the first phase, the first and fourth transistors M1, M4 are turned on, and the second and third transistors M2, M3 are turned off, as shown in FIG. 5A. The pump capacitor 11′ therefore is charged to input voltage Vᵢₙ during the first phase. During the second phase, transistors M1 and M4 are turned off, and transistors M2 and M3 are turned on, as shown in FIG. 5B.

According to the second embodiment, the adjusting means 13′ comprises an adjustable transistor 131′ having a variable impedance, coupled in series between the input voltage Vᵢₙ and the pump capacitor 11′, wherein the adjustable transistor 131′ is responsive to the control signal to adjust the variable impedance at the second phase so as to control the output voltage. Accordingly, the adjustable transistor 131′ is embodied as the third transistor M3 of the switching means 12′ such that the adjustable transistor 131′ not only controls the output voltage Vₒᵤₜ by the impedance but also switches the charge pump circuit 10′ between the first and second phases.

The feedback loop circuitry 20′ comprises a reference voltage source 21′ providing a reference voltage signal, a resistor divider 22′ coupling with the adjusting means 22′ for generating a voltage feedback signal thereto and an amplifier 23′ amplifying the voltage feedback signal with respect to the reference voltage signal so as to generate the control signal to the adjusting means 13′.

The resistor divider 22′ is coupled to the output voltage Vₒᵤₜ controls the conduction state of the third transistor M3 (i.e. the adjustable transistor 131′) so that the output voltage Vₒᵤₜ is maintained at a desired regulated voltage. In other words, the feedback loop circuitry 20′ is used to control the impedance of the third transistor M3 (131′) and thereby control the output voltage Vₒᵤₜ at a desired regulated voltage. The resistor divider 22′ comprises two resistors 221′ 222′ and a capacitor 223′. The resistor divider 22′ provides a voltage feedback signal proportional to Vₒᵤₜ at the inverting input of amplifier 23′. Accordingly, the capacitor 223′ is a feed forward capacitor and thereby a zero is added owing to the capacitor 223′ and the resistor 221′ so that the phase margin of the voltage converter is improved. In other words, the amount of phase lag of voltage converter is reduced, resulting in the improvement in the phase margin of the voltage converter. Therefore, the stability of the voltage converter is increased.

The reference voltage source 21′ provides a constant reference voltage signal at the non-inverting input of the amplifier 23′. The amplifier 23′ amplifies the difference between the feedback signal and the reference voltage and provides an amplified signal at its output to control the impedance of the third transistor M3 through a fifth transistor M5 and an inverter 25′. During the first phase, the first and second transistors M1, M4 are turned on while the second and third transistors M2, M3 are turned off, as shown in FIG. 5A, the pump capacitor 11′ therefore is charged to the input voltage Vᵢₙ during the first phase. During the second phase, the first and fourth transistors M1, M4 are turned off, while the second and third transistors M2, M3 (131′) are turned on, the current flows from the pump capacitor 11′ to the output node Nₒᵤₜ, as shown in FIG. 5B.

The fifth transistor M5 is utilized to amplify the amplified signal so as to drive the third transistor M3 (131′) during the second phase. The voltage converter also has a current source 25′ and a compensation capacitor 26′. The current source 25′ provides a constant current signal at a node N2. The compensation capacitor 26′ is coupled between the node N2 and the control electrode of the fifth transistor M5. The function of compensation capacitor 26′ is used for miller compensation of the fifth transistor M5. The node N2 is connected by the inverter 24′ to the control electrode of the third transistor M3 (131′). This causes that a voltage at node N2 tends to substantially equal to a voltage at the control electrode of the third transistor M3 (131′) during the second phase. Therefore, the conduction state of the third transistor M3 is adjusted at the voltage at node N2. Accordingly, the third transistor M3 may be treated as an adjustable resistor. The magnitude of conductive impedance of the third transistor M3 depends upon the conduction state of the third transistor M3. A conductive impedance of the second transistor M2 can be neglected because the conductive impedance of the second transistor M2 is relative small. Therefore, when the first and fourth transistors M1, M4 are turned off while the second and third transistors M2, M3 (131′) are turned on, the voltage at node N3 is shown in the following equation:
Vᵢₙ−Iₒᵤₜ*R=V_{N3} (1)
where V_{N3} is the voltage level at node 3, R is an equivalent conductive resistance of the third transistor M3, and Iₒᵤₜ is the output current. The output voltage Vₒᵤₜ at the output node Nₒᵤₜ is shown in the following equation:
Vₒᵤₜ=V_{11′}+V_{N3} (2)
where V_{11′} is the voltage across the pump capacitor 11′, and Vₒᵤₜ is the output voltage at the output node Nₒᵤₜ.

Substituting equation (1) into equation (2), one can derive the following equation:
Vₒᵤₜ=Vᵢₙ+(Vᵢₙ−Iₒᵤₜ*R)=2Vᵢₙ−Iₒᵤₜ*R (3)

For the above discussion, the transistors are operated in sequence to first charge the pump capacitor 11′ from the input voltage Vᵢₙ and then transfer the charge to the output. Therefore, the magnitude of the output voltage Vₒᵤₜ is determined by the equivalent impedance of the third transistor M3 (131′). In other words, the magnitude of the output voltage Vₒᵤₜ is controlled just only by the voltage at node 2.

It is worth to mention that in the present invention the pump capacitor 11′ is operated in the transfer phase because of the modulation of output impedance so that the voltage converter may provides an instant voltage supply in response to variations or fluctuations in the output voltage Vₒᵤₜ corresponding to load variations or fluctuations. Therefore, a higher gain operational amplifier may be utilized so as to improve the load regulation of the voltage converter which is operated in a fixed operating frequency. Furthermore, the voltage converter of the present invention must utilize the capacitors 223′, 26′ to stabilize the converter circuit. To sum up the above description, the present invention provides the voltage converter with constant-frequency operation which is adapted to perform good load regulation ability so as to prevent variations or fluctuations in the output voltage Vₒᵤₜ corresponding to load variations or fluctuations.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A DC to DC voltage converter for regulating an output voltage at an output node from an input voltage; comprising:
a charge pump circuit comprising a pump capacitor coupling at said output node, means for switching said charge pump circuit between a first phase and a second phase, and means for adjusting a magnitude of said output voltage at said second phase, wherein at said first phase, a current flows to said pump capacitor so as to charge said pump capacitor, and at said second phase, said current flows from said pump capacitor to said output node; and
a feedback loop circuitry electrically coupling with said charge pump circuit for generating a control signal to said adjusting means so as to control said output voltage at said output node in a constant manner while said current is varied.

2. The DC to DC voltage converter, as recited in claim 1, wherein said adjusting means comprises an adjustable resistor, having a variable resistance, coupled in series between said input voltage and said pump capacitor, wherein said adjustable resistor is responsive to said control signal to adjust said variable resistance at said second phase so as to control said output voltage.

3. The DC to DC voltage converter, as recited in claim 1, wherein said switching means comprises a first switch coupled between said pump capacitor and said output mode, a second switch coupled to said pump capacitor in a parallel connection, a third switch coupled between said input voltage and said second switch, and a fourth switch coupled between said input voltage and said first switch, wherein said current flows from said input voltage to said pump capacitor when said second switch and said fourth switch are closed, and said current flows from said pump capacitor to said output node when said first switch and said third switch are closed.

4. The DC to DC voltage converter, as recited in claim 2, wherein said switching means comprises a first switch coupled between said pump capacitor and said output mode, a second switch coupled to said pump capacitor in a parallel connection, a third switch coupled between said input voltage and said second switch, and a fourth switch coupled between said input voltage and said first switch, wherein said current flows from said input voltage to said pump capacitor when said second switch and said fourth switch are closed, and said current flows from said pump capacitor to said output node when said first switch and said third switch are closed.

5. The DC to DC voltage converter, as recited in claim 3, wherein said first and third switches are switched out of phase with said second and fourth switches.

6. The DC to DC voltage converter, as recited in claim 4, wherein said first and third switches are switched out of phase with said second and fourth switches.

7. The DC to DC voltage converter, as recited in claim 1, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

8. The DC to DC voltage converter, as recited in claim 2, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

9. The DC to DC voltage converter, as recited in claim 6, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

10. The DC to DC voltage converter, as recited in claim 7, wherein said feedback loop circuitry further comprises a feed forward capacitor coupled with said resistor divider in order to increase a phase margin of said DC to DC voltage converter so as to stabilize said DC to DC voltage converter.

11. The DC to DC voltage converter, as recited in claim 8, wherein said feedback loop circuitry further comprises a feed forward capacitor coupled with said resistor divider in order to increase a phase margin of said DC to DC voltage converter so as to stabilize said DC to DC voltage converter.

12. The DC to DC voltage converter, as recited in claim 9, wherein said feedback loop circuitry further comprises a feed forward capacitor coupled with said resistor divider in order to increase a phase margin of said DC to DC voltage converter so as to stabilize said DC to DC voltage converter.

13. The DC to DC voltage converter, as recited in claim 1, wherein said adjusting means comprises an adjustable transistor having a variable impedance, coupled in series between said input voltage and said pump capacitor, wherein said adjustable transistor is responsive to said control signal to adjust said variable impedance at said second phase so as to control said output voltage.

14. The DC to DC voltage converter, as recited in claim 13, wherein said switching means comprises a first transistor coupled between said pump capacitor and said output node, a second transistor coupled to said pump capacitor, and a fourth transistor coupled between said input voltage and said first transistor, wherein said adjustable transistor is coupled between said input voltage and said second transistor, wherein said current flows from said input voltage to said pump capacitor when said second transistor and said fourth transistor are turned off, and said current flows from said pump capacitor to said output node when said first transistor and said third transistor are turned off.

15. The DC to DC voltage converter, as recited in claim 13, wherein said first transistor and said adjustable transistor are switched out of phase with said second and fourth transistors.

16. The DC to DC voltage converter, as recited in claim 14, wherein said impedance of said third transistor is adjusted at a conduction state thereof.

17. The DC to DC voltage converter, as recited in claim 14, wherein said first and fourth transistors and said adjustable transistor are P-channel transistors respectively and said second transistor is a N-channel transistor.

18. The DC to DC voltage converter, as recited in claim 16, wherein said first and fourth transistors and said adjustable transistor are P-channel transistors respectively and said second transistor is a N-channel transistor.

19. The DC to DC voltage converter, as recited in claim 13, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

20. The DC to DC voltage converter, as recited in claim 14, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

21. The DC to DC voltage converter, as recited in claim 18, wherein said feedback loop circuitry comprises a reference voltage source providing a reference voltage signal, a resistor divider coupling with said adjusting means for generating a voltage feedback signal thereto and an amplifier amplifying said voltage feedback signal with respect to said reference voltage signal so as to generate said control signal to said adjusting means.

22. The DC to DC voltage converter, as recited in claim 19, wherein said feedback loop circuitry further comprises a feed forward capacitor coupled with said resistor divider in order to increase a phase margin of said DC to DC voltage converter so as to stabilize said DC to DC voltage converter.

23. The DC to DC voltage converter, as recited in claim 20, wherein said feedback loop circuitry further comprises a feed forward capacitor coupled with said resistor divider in order to increase a phase margin of said DC to DC voltage converter so as to stabilize said DC to DC voltage converter.

24. The DC to DC voltage converter, as recited in claim 21, wherein said feedback loop circuitry further comprises a feed forward capacitor coupled with said resistor divider in order to increase a phase margin of said DC to DC voltage converter so as to stabilize said DC to DC voltage converter.

25. The DC to DC voltage converter, as recited in claim 19, wherein said feedback loop circuitry further comprises a current source providing a constant current signal, a fifth transistor coupled between said current source and said amplifier to receive an amplified signal therefrom, and an inverter coupled between said current source and said fifth transistor to receive a signal amplified by said fifth transistor so as to provide said control signal, and a compensation capacitor coupled with a control electrode of said fifth transistor for miller compensation of said fifth transistor.

26. The DC to DC voltage converter, as recited in claim 21, wherein said feedback loop circuitry further comprises a current source providing a constant current signal, a fifth transistor coupled between said current source and said amplifier to receive an amplified signal therefrom, and an inverter coupled between said current source and said fifth transistor to receive a signal amplified by said fifth transistor so as to provide said control signal, and a compensation capacitor coupled with a control electrode of said fifth transistor for miller compensation of said fifth transistor.

27. The DC to DC voltage converter, as recited in claim 24, wherein said feedback loop circuitry further comprises a current source providing a constant current signal, a fifth transistor coupled between said current source and said amplifier to receive an amplified signal therefrom, and an inverter coupled between said current source and said fifth transistor to receive a signal amplified by said fifth transistor so as to provide said control signal, and a compensation capacitor coupled with a control electrode of said fifth transistor for miller compensation of said fifth transistor.

28. The DC to DC voltage converter, as recited in claim 25, wherein said fifth transistor is a N-channel transistor.

29. The DC to DC voltage converter, as recited in claim 26, wherein said fifth transistor is a N-channel transistor.

30. The DC to DC voltage converter, as recited in claim 27, wherein said fifth transistor is a N-channel transistor.
